(19) United States
(12) Patent Application Publication
(10) Pub. No.: US 2005/0017640 A1
(43) Pub. Date: Jan. 27, 2005

(54) Plasma display panel and fabrication method thereof

(75) Inventors: Tae In Kwon, Seoul (KR); Byung Gil Ryu, Seoul (KR); Won Seok Moon, Seoul (KR); Sung Wook Lee, Gyeonggi-Do (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 10/752,749

(22) Filed: Jan. 2, 2004

(30) Foreign Application Priority Data
Jul. 26, 2003 (KR) 2003-51819

(51) Int. Cl. H01J 17/49; H01J 9/00

(52) U.S. Cl. 313/586; 313/587; 445/24

(57) ABSTRACT

A plasma display panel (PDP) and its fabrication method are disclosed. The PDP includes a dielectric transfer film containing a ceramic pigment instead of a conventional upper dielectric layer, so that a color purity and a contrast ratio can be increased, the thickness of the dielectric thin film can be uniform, and a voltage margin and discharging can be uniform.

### BACKGROUND OF THE INVENTION

1. Field of the Invention

The present invention relates to a plasma display panel (PDP) and, more particularly, to a PDP and its fabrication method capable of enhancing a color purity and a contrast ratio.

2. Description of the Prior Art

In general, a plasma display panel (PDP) device receives much attention as a next-generation display device together with a thin film transistor (TFT), a liquid crystal display (LCD), an EL (Electro-Luminescence) device, an FED (Field Emission Display) and the like.

The PDP is a display device which uses a luminescent phenomenon according to an energy difference made when red, green and blue fluorescent materials are changed from an excited state to a ground state after being excited by 147 nm of ultraviolet rays which are generated as a He+X3 gas or N3+X3 gas is discharged from a discharge cell isolated by a barrier rib.

Thanks to its properties of facilitation in manufacturing from a simple structure, a high luminance, a high light emitting efficiency, a memory function, a high non-linearity, a 160° or wider optical angular field and the like, the PDP display device is anticipated to occupy a 40″ or greater large-scale display device markets.

A structure of the conventional PDP will now be described with reference to FIG. 1.

FIG. 1 is a sectional view showing a structure of a conventional PDP.

As shown in FIG. 1, the conventional PDP includes: a lower insulation layer 20 formed on a lower glass substrate 21; an address electrode 22 formed on the lower insulation layer 20; a lower dielectric layer 19 formed on the address electrode 22 and the lower insulation layer 20; an isolation wall 17 defined in a predetermined portion on the lower dielectric layer 19 in order to divide each discharging cell; a black matrix layer 16 formed on the isolation wall 17; a fluorescent layer 18 formed with a predetermined thickness on the side of the black matrix layer 16 and the isolation wall 17 and on the lower dielectric layer 19, and receiving ultraviolet ray and emitting each red, green and blue visible rays; a glass substrate 11; a sustain electrode 12 formed at a predetermined portion on the upper glass substrate 11 in a manner of vertically intersecting the address electrode 22; a bus electrode 12 formed on a predetermined portion on the sustain electrode 12; an upper dielectric layer 14 formed on the bus electrode 13, the sustain electrode 12 and the upper glass substrate 11; and a protection layer (MgO) 15 formed on the second upper dielectric layer 14 in order to protect the upper dielectric layer 14.

The operation of the conventional PDP will now be described.

First, as the upper glass substrate 11 and the lower glass substrate 21 of the conventional PDP, an SLS (Soda-Lime Silicate) glass substrate is used.

The lower insulation layer 20 is positioned on the lower glass substrate 21, the SLS glass substrate, and the address electrode 22 is positioned on the lower insulation layer 20.

The lower dielectric layer 19 positioned on the address electrode 22 and the lower insulation layer 20 blocks visible rays emitted toward the lower glass substrate 21.

In order to increase the luminous efficacy, a dielectric layer having a high reflectance is used as the lower dielectric layer 19. The lower dielectric layer 19, a translucent dielectric layer with a reflectance of 60% or above, minimizes loss of light.

Meanwhile, at a lower surface of the upper glass substrate 11, the SLS glass substrate, there are formed the sustain electrode 12 positioned to vertically intersect the address electrode 22 and the bus electrode 13 positioned on the sustain electrode 12. And upper dielectric layer is positioned on the bus electrode 13.

The protection layer 15 is positioned on the upper dielectric layer 14 in order to prevent the upper dielectric layer 14 from being damaged due to generation of plasma. Herein, since the upper dielectric layer 14 is directly contacted with the sustain electrode 12 and the bus electrode 13, it must have a high softening temperature in order to avoid a chemical reaction with the sustain electrode 12 and the bus electrode 13.

The fluorescent layer 18, which is laminated in a sequential order of red, green and blue fluorescent materials, emits visible rays of a specific wavelength according to an intensity of ultraviolet rays according to plasma generated from a region between isolation walls 17.

In order to prevent a phenomenon that the fluorescent materials, the dielectric collide with accelerated gas ions and they are deteriorated, a discharge gas (N3) with a big molecular weight is used as a principal component to reduce the ion collision phenomenon.

In this case, however, a color purity of the PDP is degraded due to an orange-colored visible ray generated when the Ne gas is discharged. In addition, a contrast of the PDP is also degraded due to the degraded color purity of fluorescent materials and a surface reflection of an external light.

In an effort to solve the problems, in the conventional art, a color filer or a black stripe (not shown) is applied to an upper plate of the PDP.

The structure of a PDP adopting the color filer will now be described.

A color filer layer (not shown) is formed between the upper dielectric layer 14 and the protection layer 15 in order to heighten the color purity and prevent a surface reflection owing to an external light. The color filter layer can be formed on the protection layer 15 or embedded in the upper dielectric layer 14. In addition, the color filer layer can substitute the upper dielectric layer 14.

However, additional application of the color filter layer to the PDP complicates the fabrication process of the PDP.

Meanwhile, employing the black stripe for the PDP would cause a degradation of an aperture area, which would lead to a degradation of a luminous efficacy.

In addition, due to the relatively low luminous efficacy of the blue fluorescent material compared with the red and green fluorescent materials, a color temperature of the PDP becomes very low.

To sum up, first, application of the black stripe to the PDP is not disadvantageous in that the aperture area is degraded and thus the luminous efficacy is also degraded.

Second, application of the color filer layer to the PDP makes the fabrication process of the PDP complicate.

Third, due to the relatively low luminous efficacy of the blue fluorescent material compared with the red and green fluorescent materials, the color temperature of the PDP is too much lowered.

Other conventional PDPs and their fabrication methods are disclosed in the U.S. Pat. No. 5,838,106 issued on Nov. 17, 1998, a U.S. Pat. No. 6,242,859 issued on Jun. 5, 2001, and a U.S. Pat. No. 6,599,851 issued on Jul. 29, 2003.

### SUMMARY OF THE INVENTION

Therefore, one object of the present invention is to provide a plasma display panel (PDP) and its fabrication method capable of increasing a color purity and a contrast ratio by forming a dielectric transfer film containing a pigment that is able to control a light transmittance instead of forming an upper dielectric layer.

Another object of the present invention is to provide a PDP and its fabrication method capable of making the thickness of a dielectric thin film even and making a voltage margin and discharging uniform when a gas of a PDP is discharged by substituting an upper dielectric layer with a dielectric transfer film.

Still another object of the present invention is to provide an environment-friendly PDP by using a PbO, P₂O₅ and ZnO-based glass composition as a dielectric material, and its fabrication method.

To achieve these and other advantages and in accordance with the purpose of the present invention, as embodied and broadly described herein, there is provided a PDP including a dielectric transfer film containing a ceramic pigment.

To achieve the above objects, there is also provided a fabrication method of a PDP including: forming a dielectric transfer film containing a ceramic pigment on an upper glass substrate, a sustain electrode and a bus electrode.

To achieve the above objects, there is also provided a PDP including a dielectric transfer film containing a pigment controlling a light transmittance, in which an upper dielectric layer is substituted with the dielectric transfer film.

To achieve the above objects, there is also provided a fabrication method of a PDP including: forming a sustain electrode and a bus electrode on an upper glass substrate of a PDP; and forming a dielectric transfer film containing a pigment controlling a light transmittance on the upper glass substrate, the sustain electrode and the bus electrode.

In the fabrication method of a PDP, the step of forming a dielectric transfer film of the PDP includes: fabricating glass by mixing the pigment to a parent glass; forming glass powder by crushing the fabricated glass, mixing the glass powder and a binder in a solvent which dissolves the binder to form slurry; shaping the slurry to a transfer film; coating the transfer film on the upper glass substrate, the sustain electrode and the bus electrode; and firing the coated transfer film to form the dielectric transfer film.

The pigment applied to the dielectric transfer film of the PDP is one of CuO, CoO, Nd₂O₃, NiO, Cr₂O₃, Pr₂O₃ and Fe₂O₃.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view showing a structure of a PDP in accordance with a conventional art;

FIG. 2 is a sectional view showing a structure of a PDP adopting a dielectric transfer film in accordance with the present invention;

FIGS. 3A and 3B show two types of dielectric transfer films of the PDP in accordance with the present invention;

FIG. 4 is a flow chart of a method for forming the dielectric transfer film on an upper glass substrate of a PDP in accordance with the present invention;

FIG. 5 is a flow chart of a method for fabricating the dielectric transfer film in accordance with the present invention; and

FIG. 6 is a graph showing a result from measurement of a light transmittance of the PDP in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

A PDP and its fabrication method capable of increasing a color purity and a contrast ratio, making the thickness of a dielectric thin film uniform, and making a voltage margin and discharging uniform when a gas of a PDP is discharged, by applying a dielectric transfer film containing a ceramic pigment, instead of an upper dielectric layer, to the PDP, in accordance with a preferred embodiment of the present invention will now be described.

Herein, the voltage margin is a difference between a voltage when a screen of the PDPI is initially turned on as a gas in the PDP is discharged and a voltage when the screen of the panel is completely turned on.

For example, the voltage margin means a difference between an initially applied voltage and a predetermined voltage when the voltage applied to the PDP is gradually increased to maintain the predetermined voltage.

In addition, when the PDP is turned on, if the thickness of the dielectric layer is not uniform, the voltage margin is reduced.

However, since the dielectric transfer film in accordance with the present invention is uniform in its thickness, the difference value between the initially applied voltage and the predetermined voltage is reduced, and thus, the voltage margin increases. Accordingly, when the gas in the PDP is discharged, the screen of the panel can be maintained to be uniform.

A PbO, P₂O₅ and ZnO-based glass composition is used as the dielectric transfer film, so that an environment-friendly PDP and its fabrication method can be provided.

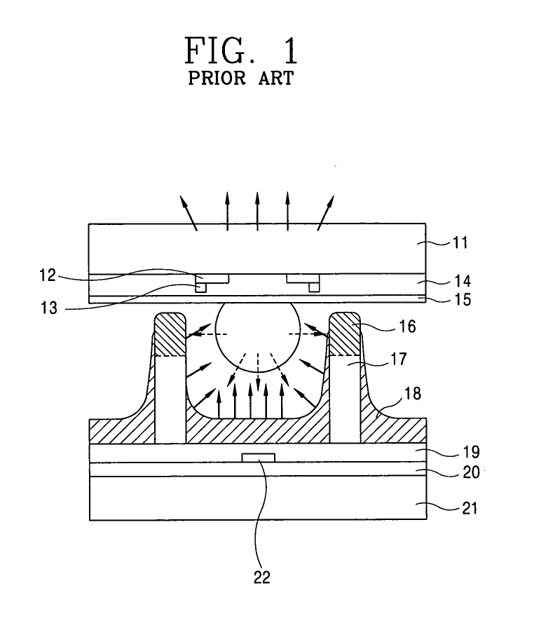

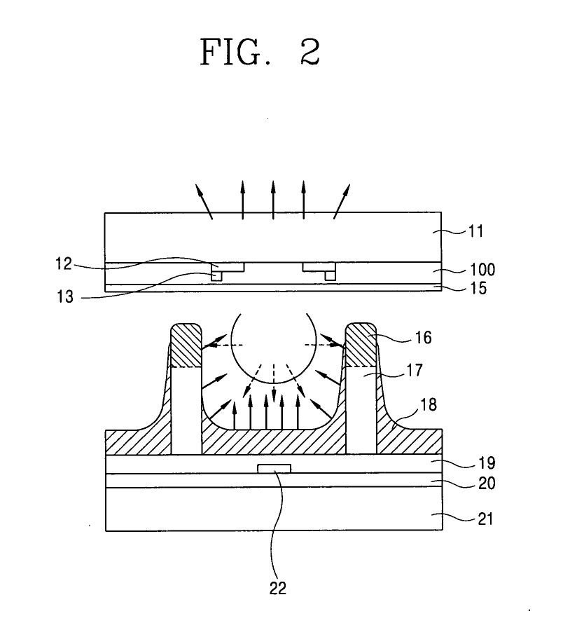

FIG. 2 is a sectional view showing a structure of a PDP adopting a dielectric transfer film in accordance with the present invention. The construction of the PDP of FIG. 2 includes the same elements with the same reference numerals as in FIG. 1 of the conventional art, descriptions for which are thus omitted, except for a dielectric transfer film 100 substituting the upper dielectric layer 14 of the conventional art.

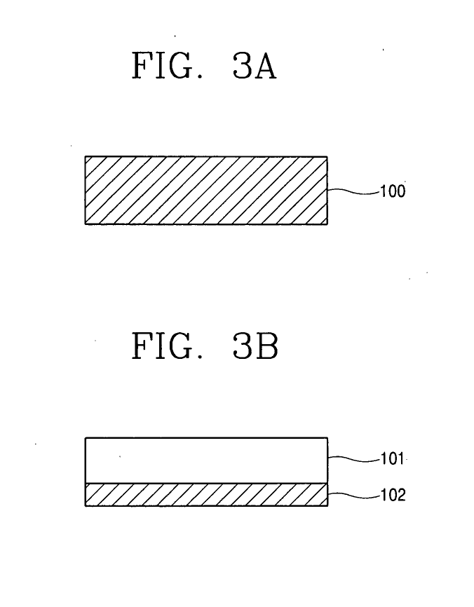

The dielectric transfer film 100 will now be described in detail with reference to FIGS. 3A and 3B.

FIGS. 3A and 3B show two types of dielectric transfer films of the PDP in accordance with the present invention. The dielectric transfer film 100 is applied instead of the upper dielectric layer to the PDP.

With reference to FIG. 3A, the dielectric transfer film 100 includes 5 wt % or less of pigment (e.g., a ceramic pigment).

Meanwhile, with reference to FIG. 3B, the dielectric transfer film 100 includes a dielectric layer 101 without a pigment and a dielectric layer 102 containing 10 wt % or less of pigment.

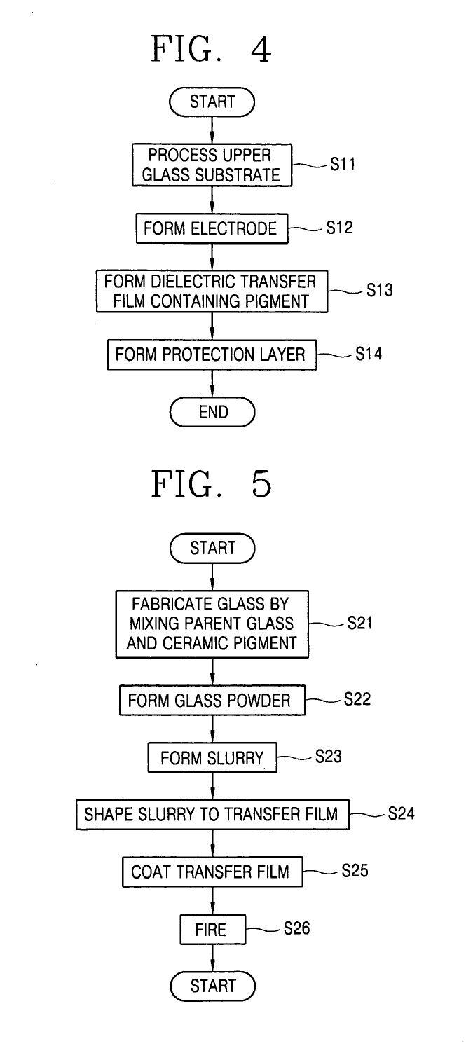

A method for forming a dielectric transfer film on the upper glass substrate of the PDP will now be described with reference to FIG. 4.

FIG. 4 is a flow chart of a method for forming the dielectric transfer film on an upper glass substrate of a PDP in accordance with the present invention.

As shown in FIG. 4, the method for forming a dielectric transfer film on an upper glass substrate of the PDP includes: processing an upper glass substrate of a PDP (step S11); sequentially depositing a sustain electrode and a bus electrode on the upper glass substrate (step S12); forming a dielectric transfer film containing a pigment controlling a light transmittance on the exposed sustain electrode, the bus electrode and the upper glass substrate (step S13); and forming a MgO protection layer on the dielectric transfer film. It is noted that the dielectric transfer film is formed, instead of the upper dielectric layer of the PDP of the conventional art, on the exposed sustain electrode, the bus electrode and the upper glass substrate.

A method for fabricating the dielectric transfer film in accordance with the present invention will now be described with reference to FIG. 5.

FIG. 5 is a flow chart of a method for fabricating the dielectric transfer film in accordance with the present invention.

As shown in FIG. 5, the method for fabricating the dielectric transfer film includes: mixing a ceramic pigment for controlling a light transmittance to parent glass to fabricate glass; crushing the formed glass to a predetermined size (e.g., 1˜5 um) to form glass powder; mixing the glass powder and a binder in a solvent which dissolves the binder to form slurry; shaping the slurry to a transfer film; coating the transfer film on the exposed sustain electrode, the bus electrode and the upper glass substrate; firing the coated transfer film at a predetermined temperature for a predetermined time to form a dielectric transfer film that can substitute the upper dielectric layer.

The dielectric transfer film is formed, instead of the upper dielectric layer of the conventional art, on the sustain electrode, the bus electrode and the upper glass substrate.

The method for fabricating the dielectric transfer film in accordance with the present invention will now be described in detail.

First, a ceramic pigment which is able to control a light transmittance is mixed to a parent glass to fabricate glass (step S21). The parent glass is made of one of PbO—B₂O₃—SiO₂+Al₂O₃—BaO-based glass (Table 1), P₂O₅—B₂O₃—ZnO-based glass (Table 2), and ZnO—B₂O₃—RO-based glass (Table 3).

TABLE 1

| | Parent glass of PbO—B₂O₃—SiO₂ + Al₂O₃—BaO group | | | |
|---|---|---|---|---|
| Embodiment | PbO | B₂O₃ | SiO₂ + Al₂O₃ | BaO |
| First | 35.5 wt % | 35.5 wt % | 20 wt % | 10.0 wt % |
| Second | 40.0 wt % | 30.5 wt % | 15 wt % | 14.5 wt % |
| Third | 45.0 wt % | 25.0 wt % | 10 wt % | 20.0 wt % |
| Fourth | 50.0 wt % | 27.0 wt % | 5 wt % | 18.0 wt % |
| Fifth | 60.0 wt % | 30.0 wt % | 0 | 10.0 wt % |

TABLE 2

| | Parent glass of B₂O₃—ZnO—P₂O₅ group | | |
|---|---|---|---|
| Embodiment | B₂O₃ | ZnO | P₂O₅ |
| First | 0 wt % | 46.2 wt % | 53.8 wt % |
| Second | 3.3 wt % | 44.7 wt % | 52.0 wt % |
| Third | 6.8 wt % | 43.1 wt % | 50.1 wt % |
| Fourth | 10.4 wt % | 41.4 wt % | 48.2 wt % |
| Fifth | 14.1 wt % | 39.7 wt % | 46.2 wt % |
| Sixth | 18.0 wt % | 37.9 wt % | 44.1 wt % |
| Seventh | 22.0 wt % | 36.1 wt % | 41.9 wt % |

TABLE 3

| | Parent glass of ZnO—B₂O₃—RO group | | |
|---|---|---|---|
| Embodiment | ZnO | B₂O₃ | RO |
| First | 19.8 wt % | 42.4 wt % | 37.8 wt % |
| Second | 24.6 wt % | 37.9 wt % | 37.5 wt % |
| Third | 29.3 wt % | 33.4 wt % | 37.3 wt % |
| Fourth | 34.0 wt % | 29.0 wt % | 37.0 wt % |

In the above Table 1, 2 and 3, the composition ratio of the parent glass is obtained by assuming that the weight of the parent glass is 100 wt %. Preferably, one of BaO, SrO, La₂O and Bi₂O₃ is used as an alkaline-earth metal oxide (RO), a component of the parent glass of Table 3. And preferably, one of CuO, CoO, Nd₂O₃, NiO, Cr₂O₃, Pr₂O₃, Fe₂O₃ is used as a pigment.

Thereafter, when glass is fabricated by mixing one of the compositions of the parent glass of Table 1, 2 and 3 with a pigment, the glass is crushed to a size of 1˜5 um to form glass powder (step S22).

The glass powder is mixed with binder of an acryl group in a solvent such as toluene, ethyl acetate, acetone or MEK (Methyl Ethyl Ketone) which can dissolve the binder, to form slurry (step S23).

The slurry is shaped by using a doctor blade to form a transfer film (step S24). The transfer film is formed as one dielectric layer containing a 5 wt % or less of pigment. Or, the transfer film can be formed as the dielectric layer 101 without a pigment and the dielectric layer 102 containing 20 wt % or less of pigment.

The transfer film is coated on the previously formed sustain electrode, the bus electrode and the upper glass substrate (step S25), and the coated transfer film is fired at a range of 550° C.˜600° C., thereby completing formation of the dielectric transfer film on the sustain electrode, the bus electrode and the upper glass substrate (step S26). The thickness of the dielectric transfer film is preferably 20˜40 um.

Thereafter, an MgO protection layer 15 is formed on the dielectric transfer film.

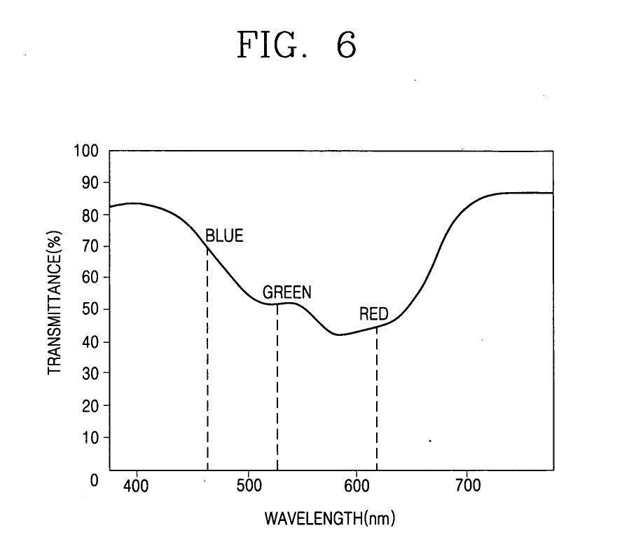

A light transmittance of the PDP adopting the dielectric transfer film according to wavelength will now be described with reference to FIG. 6.

FIG. 6 is a graph showing a result from measurement of a light transmittance of the PDP in accordance with the present invention.

With reference to FIG. 6, it is noted that the light transmittance of the blue fluorescent material (454 nm) is higher than the light transmittance of red and green fluorescent materials (611 nm and 525 nm), and therefore, the color temperature and contrast of the PDP are considerably improved.

In addition, by applying the dielectric transfer film, instead of the conventional upper dielectric layer, to the PDP, the dielectric layer can be formed with a uniform thickness, and thus, discharge characteristics of the PDP can be uniform.

Meanwhile, in the present invention, possibly, one of the parent glasses of Table 1˜3 is mixed with a pigment to fabricate glass, the fabricated glass is crushed to produce glass powder, the glass powder is mixed with a vehicle, a mixture of a solvent and a binder, to produce a paste, and then, the paste is formed as a thin film on sustain electrode, the bus electrode and the upper glass substrate.

As so far described, the composition of glass for PDP and its fabrication method of the present invention have the following advantages.

That is, by forming the dielectric transfer film containing a pigment which is able to controlling a light transmittance, instead of the conventional upper dielectric layer, the color purity and the contrast ratio of the PDP can be heightened.

In addition, by forming the dielectric transfer film containing a pigment which is able to controlling a light transmittance, instead of the conventional upper dielectric layer, the thickness of the dielectric layer can be uniform, and a voltage margin and the discharging when a gas of the PDP is discharged can be uniform.

Moreover, in the present invention, the P₂O₅-based and ZnO-based glasses as well as the PbO-based glass, are used as a parent glass. That is, the used materials are harmless to the human body and the environment.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A PDP comprising:
a dielectric transfer film containing a ceramic pigment.

2. The PDP of claim 1, wherein the ceramic pigment is contained in the dielectric transfer film in order to control a light transmittance.

3. The PDP of claim 1, wherein the dielectric transfer film is formed as an upper dielectric layer of the PDP.

4. The PDP of claim 1, wherein the dielectric transfer film includes 5 wt % or less ceramic pigment.

5. The PDP of claim 1, wherein the dielectric transfer film comprises:
a dielectric layer without containing a ceramic pigment; and
a dielectric layer containing a 20 wt % or less ceramic pigment.

6. The PDP of claim 1, wherein the ceramic pigment is one of CuO, CoO, Nd₂O₃, NiO, Cr₂O₃, Pr₂O₃ and Fe₂O₃.

7. A fabrication method of a PDP comprising:
forming a dielectric transfer film containing a ceramic pigment on an upper glass substrate, a sustain electrode and a bus electrode.

8. The method of claim 7, wherein the dielectric transfer film is formed as an upper dielectric layer of the PDP.

9. The method of claim 7, wherein the step of forming a dielectric transfer film of the PDP comprises:
fabricating glass by mixing the pigment to a parent glass;
forming glass powder by crushing the fabricated glass, mixing the glass powder in a binder and a solvent dissolving the binder to form slurry;
shaping the slurry to a transfer film;
coating the transfer film on the upper glass substrate, the sustain electrode and the bus electrode; and
firing the coated transfer film to form the dielectric transfer film.

10. The method of claim 9, wherein the parent glass is one of PbO—B₂O₃—SiO₂+Al₂O₃—BaO-based glass, P₂O₅—B₂O₃—ZnO-based glass and ZnO—B₂O₃—RO-based glass, and RO is one of BaO, SrO, La₂O and Bi₂O₃.

11. The method of claim 9, wherein the dielectric transfer film is formed as one dielectric layer containing 5 wt % or less ceramic pigment.

12. The method of claim 9, wherein the dielectric transfer film comprises:
a dielectric layer without containing the ceramic pigment; and
a dielectric layer containing 20 wt % or less ceramic pigment.

13. The method of claim 9, wherein the ceramic pigment is one of CuO, CoO, Nd₂O₃, NiO, Cr₂O₃, Pr₂O₃ and Fe₂O₃.

14. A PDP comprising:
a dielectric transfer film containing a pigment controlling a light transmittance,
wherein an upper dielectric layer is substituted with a dielectric transfer film.

15. The PDP of claim 14, wherein the pigment is one of CuO, CoO, Nd₂O₃, NiO, Cr₂O₃, Pr₂O₃ and Fe₂O₃.

16. A fabrication method of a PDP comprising:
forming a sustain electrode and a bus electrode on an upper glass substrate of a PDP; and
forming a dielectric transfer film containing a pigment controlling a light transmittance on the upper glass substrate, the sustain electrode and the bus electrode.

17. The method of claim 16, wherein the step of forming a dielectric transfer film of the PDP comprises:
fabricating glass by mixing the pigment to a parent glass;
forming glass powder by crushing the fabricated glass, mixing the glass powder in a binder and a solvent dissolving the binder to form slurry;
shaping the slurry to a transfer film;
coating the transfer film on the upper glass substrate, the sustain electrode and the bus electrode; and
firing the coated transfer film to form the dielectric transfer film.

18. The method of claim 17, wherein the parent glass is one of PbO—B₂O₃—SiO₂+Al₂O₃—BaO-based glass, P₂O₅—B₂O₃—ZnO-based glass and ZnO—B₂O₃—RO-based glass, and RO is one of BaO, SrO, La₂O and Bi₂O₃.

19. The method of claim 17, wherein the dielectric transfer film is formed as one dielectric layer containing 5 wt % or less ceramic pigment, or comprises a dielectric layer without containing the ceramic pigment; and a dielectric layer containing 20 wt % or less ceramic pigment.

20. The method of claim 19, wherein the pigment is one of CuO, CoO, Nd₂O₃, NiO, Cr₂O₃, Pr₂O₃ and Fe₂O₃.
